(19) United States
(12) Patent Application Publication
(10) Pub. No.: US 2011/0106588 A1
(43) Pub. Date: May 5, 2011

(54) System and Method to Facilitate Installation of a Digital Subscriber Line

(75) Inventors: James Gordon Beattie, JR., Bergenfield, NJ (US); Eric Forbes, Canton, GA (US); William H. Greer, Marietta, GA (US); Stephen J. Griesmer, Westfield, NJ (US); Arvind Ramdas Mallya, Walnut Creek, CA (US)

(73) Assignee: AT&T INTELLECTUAL PROPERTY I, L.P., Reno, NV (US)

(21) Appl. No.: 12/609,531

(22) Filed: Oct. 30, 2009

(51) Int. Cl. G06Q 50/00; G06Q 10/00; G06F 17/30; G06F 15/00

(52) U.S. Cl. 705/7.38; 702/182; 707/E17.014; 707/E17.018; 707/E17.044

(57) ABSTRACT

Systems and methods to facilitate installation of a digital subscriber line are provided. A particular computer-implemented method includes receiving an installation request for a digital subscriber line. The method includes determining performance data associated with one or more active digital subscriber lines that are located near an installation location of the digital subscriber line. The method includes comparing the performance data to installation criteria. The method also includes sending an installation notice to an installer. The installation notice includes a special installation instruction when the performance data satisfies at least one installation criterion of the installation criteria.

### FIELD OF THE DISCLOSURE

The present disclosure is generally related to facilitating installation of a digital subscriber line.

### BACKGROUND

A digital subscriber line service provider may receive requests for new digital subscriber lines. When a request for a new digital subscriber line is received, the digital subscriber line service provider may determine if a location for the new digital subscriber line is within a threshold distance of existing equipment needed to provide quality service for the new digital subscriber line. When the location is within the threshold distance, the digital subscriber line service provider contacts an installer to install the new digital subscriber line. However, even when the length of the new digital subscriber line is acceptable based on the threshold distance, the new digital subscriber line may experience reduced performance due to other issues, such as radio frequency interference.

### BRIEF DESCRIPTION OF THE DRAWINGS

FIG. 1 is a block diagram of a first particular embodiment of a system to facilitate installation of a digital subscriber line.

FIG. 2 is a graph depicting bits loading versus tone for a first particular digital subscriber line.

FIG. 3 is a graph depicting bits loading versus tone for a second particular digital subscriber line.

FIG. 4 is a graph depicting noise versus tone for a third particular digital subscriber line without a high pass filter.

FIG. 5 is a graph depicting noise versus tone for the third particular digital subscriber line with a high pass filter.

FIG. 6 is a graph depicting data rate versus tone for the third particular digital subscriber line without a high pass filter.

FIG. 7 is a graph depicting data rate versus tone for the third particular digital subscriber line with the high pass filter.

FIG. 8 is a flow diagram of a particular embodiment of a method to facilitate installation of a digital subscriber line.

FIG. 9 is a block diagram of an illustrative embodiment of a general computer system.

### DETAILED DESCRIPTION

In a particular embodiment, a computer-implemented method includes receiving an installation request for a digital subscriber line. The method includes determining performance data associated with one or more active digital subscriber lines that are located near an installation location of the digital subscriber line. The method includes comparing the performance data to installation criteria. The method also includes sending an installation notice to an installer. The installation notice includes a special installation instruction when the performance data satisfies at least one installation criterion of the installation criteria.

In a particular embodiment, a system includes a processor and a processor-readable storage medium coupled to the processor. The processor-readable storage medium includes instructions executable by the processor to receive an installation request for a digital subscriber line. The processor-readable storage medium includes instructions executable by the processor to determine performance data associated with one or more active digital subscriber lines located near an installation location of the digital subscriber line. The processor-readable storage medium includes instructions executable by the processor to determine an estimated loop length of the first digital subscriber line. The processor-readable storage medium also includes instructions executable by the processor to provide a special notice to an installer when the performance data indicates amplitude modulated (AM) broadcast interference in a low frequency portion of the one or more active digital subscriber lines, use of high pass filtering measures on the one or more active digital subscriber lines, and when the estimated loop length satisfies a threshold.

In a particular embodiment, a computer-readable storage medium includes operational instructions that, when executed by a processor, cause the processor to receive an installation request for a new digital subscriber line. The computer-readable storage medium includes operational instructions that, when executed by the processor, cause the processor to determine whether active digital subscriber lines located near an installation location of the new digital subscriber line have low frequency impairments. The computer-readable storage medium also includes operational instructions that, when executed by the processor, cause the processor to provide a notice to an installer of the new digital subscriber line to use high pass filters on in-house ports connected to customer premises equipment when the active digital subscriber lines have low frequency impairments.

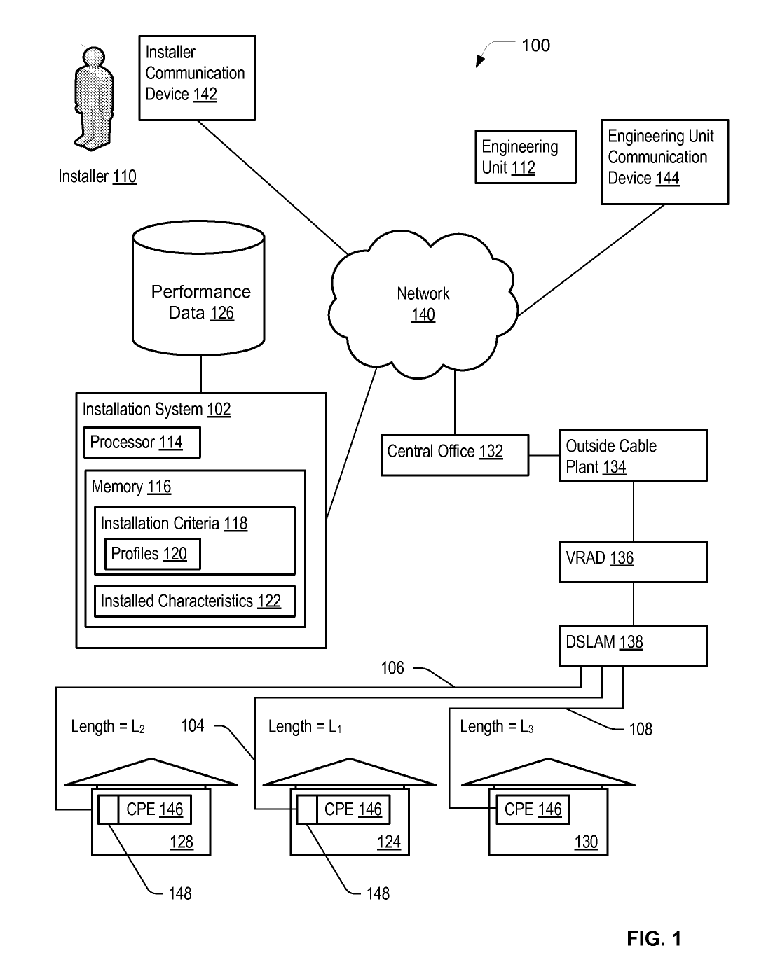

Referring to FIG. 1, a block diagram of a particular embodiment of a system to facilitate installation of a digital subscriber line is illustrated and designated generally 100. The system 100 may include an installation system 102 adapted to determine installation characteristics related to a new digital subscriber line 104 for a customer in an area that already has active digital subscriber lines, such as active digital subscriber lines 106 and 108. The installation system 102 may provide installation instructions related to the new digital subscriber line 104 to appropriate functional units, such as to an installer 110, an engineering unit 112, or both. The installation system 102 may be invoked when a request to install the new digital subscriber line 104 is received.

The installation system 102 may include a processor 114 and a memory 116 accessible to the processor 114. The memory 116 may include a plurality of installation criteria 118. The installation criteria 118 may describe profiles 120 associated with various performance quality properties that are desired for new digital subscriber lines. For example, the profiles 120 may include information regarding overutilization of one or more portions of a radio frequency (RF) spectrum used by the digital subscriber lines and information regarding acceptable limits regarding amplitude modulation (AM) broadcast interference. The memory 116 may also include information regarding the new digital subscriber line 104 to be installed. For example, the memory 116 may include installed characteristics 122 related to the new digital subscriber line 104. The installed characteristics 122 may include information such as a Length L₁ of the new digital subscriber line 104, an installation location (such as location 124) associated with the new digital subscriber line 104, information regarding services to be provided via the digital subscriber line 104, other information descriptive of the new digital subscriber line 104, or any combination thereof. When a local loop for the new digital subscriber line 104 has not been installed, a value for the loop length may be an estimate of the actual loop length.

The installation system 102 may also have access to a performance database 126. Digital subscriber line service providers may deploy local network environments to service customers. Characteristics of local loops of the local network environments may be routinely measured to provide indications of current issues with the customers. The performance database 126 may include information regarding performance and properties of active digital subscriber lines, such as the active digital subscriber lines 106, 108. For example, the performance database 126 may include information regarding installation locations 128 and 130 of active digital subscriber lines 106 and 108, respectively. The information in the performance database 126 may include a loop length of the active digital subscriber lines. For example, the information in the performance database 126 may indicate that a loop length of the digital subscriber line 106 is L₂ (e.g., about 2250 feet) and that a loop length of the digital subscriber line 108 is L₃ (e.g., about 900 feet).

The installation system 102 may be associated with a digital subscriber line service provider having facilities such as a central office 132 and an outside cable plant 134. The digital subscriber line service provider may provide video information via the digital subscriber lines using a video remote access device (VRAD) 136 and at least one digital subscriber line access multiplexer (DSLAM) 138. Additionally, the digital subscriber line service provider may have one or more functional units to facilitate installation of new digital subscriber lines, to maintain existing digital subscriber lines, and to facilitate communications through a network 140 associated with the digital subscriber line provider.

The functional units associated with the digital subscriber line service provider may include installation service providers, such as the installer 110 associated with an installer communication device 142, and the engineering unit 112 associated with an engineering unit communication device 144. The communication devices 142, 144 may be telephones, computers, personal digital assistants, or other types of communication devices. The installer 110 may facilitate installation of new digital subscriber lines, such as the new digital subscriber line 104. The installer 110 may install the local loop, make appropriate connections to equipment of the digital subscriber line service provider, or both. The installer 110 may also provide communications equipment to be installed at the installation location 124, such as customer premises equipment (CPE) 146, a high pass filter 148, or both.

The engineering unit 112 may facilitate design and specification of elements of the digital subscriber line service provider network. For example, the engineering unit 112 may specify the locations and the particular devices to be used in establishing a digital subscriber line service provider network. The equipment may include, but is not limited to, the outside cable plant 134, the VRAD 136, the DSLAM 138, and other portions of the digital subscriber line service provider network.

In operation, the installation system 102 may receive an installation request for the new digital subscriber line 104. In response to the installation request, the installation system 102 may determine performance data associated with one or more active digital subscriber lines, such as the digital subscriber lines 106, 108 that are located near the installation location 124 of the new digital subscriber line 104. The one or more active digital subscriber lines 106, 108 used by the installation system 102 may use one or more pieces of the same equipment that are to be used by the new digital subscriber line 104 (e.g., the outside cable plant 134, the VRAD 136, and the DSLAM 138). The installation system 102 may also determine the estimated loop length, such as the loop length L₁ of the new digital subscriber line 104. The installation system 102 may provide a notice to at least one of the functional units of the digital subscriber line network based on a comparison of the installation criteria 118 to the information obtained from the performance database 126, the installed characteristics 122, or both

When the comparison indicates that the new digital subscriber line 104 will provide satisfactory service, the installation system 102 notice may be a notice to the installer 110 to install the new digital subscriber line 104. When the comparison indicates that the new digital subscriber line satisfies one or more of the installation criteria 118, the installation system 102 may provide special installation instructions in the notice. For example, a special instructions sent to the installer 110 may indicate an expectation of quality issues with the new digital subscriber line 104, an instruction to perform one or more tests on the new digital subscriber line 104, an instruction to take testing equipment to the location 124, an instruction to take particular equipment to be installed at the location 124 (e.g., a high pass filter 148), another special installation instruction, or combinations thereof. Special instructions for the engineering unit 112 may include an instruction to change the existing equipment of the digital subscriber line network to provide satisfactory performance for the customer associated with the new digital subscriber line 104, existing customers, or future new customers. The change may involve moving one or more pieces of existing equipment (e.g., the outside cable plant 134, the VRAD 136, and the DSLAM 138) to a different location to decrease the loop length, upgrading one or more of the existing pieces of equipment, adding new equipment (e.g., a new outside cable plant 134, a new VRAD 136, a new DSLAM 138, or combinations thereof) to better service a particular area, performing other actions to increase quality of service to the customers, or combinations thereof.

In a particular embodiment, a notice with special instructions may be sent to the installer 110 when at least one of the performance data from the performance database 126 indicate AM broadcast interference in a low frequency portion of one or more of the active digital subscriber lines 106, 108, and when the AM broadcast interference is above a threshold specified in the installation criteria 118. The special instructions to the installer 110 may indicate a need to install a high pass filter during the installation.

In a particular embodiment, notices with special instructions may be sent to the installer 110, to the engineering unit 112, or both when the installed characteristics 122 indicate an estimated loop length L₁ of the new digital subscriber line 104 satisfies a threshold specified in the installation criteria 118. For example, the threshold may be set at approximately 2000 feet. In another example, the threshold may be longer or shorter than 2000 feet as needed or desired based on performance data associated with the digital subscriber line service provider network. In another example, the threshold may be about 2500 feet. The special instructions to the installer 110 may instruct the installer 110 to perform one or more quality of service tests at the location 124 after installation is completed. The special instructions to the engineering unit 112 may instruct the engineering unit 112 to change the equipment used by the new digital subscriber line 104. In some embodiments, the special instructions to the engineering unit 112 may be sent to the engineering unit 112 when a threshold number of new installations that use a particular set of equipment (e.g., the cable plant 134, the VRAD 136, or the DSLAM 138) satisfy the installation criteria 118. The threshold number may be 1, 2, 5, 10, or any other desired number based on the number of digital subscriber lines that can be supported by the equipment.

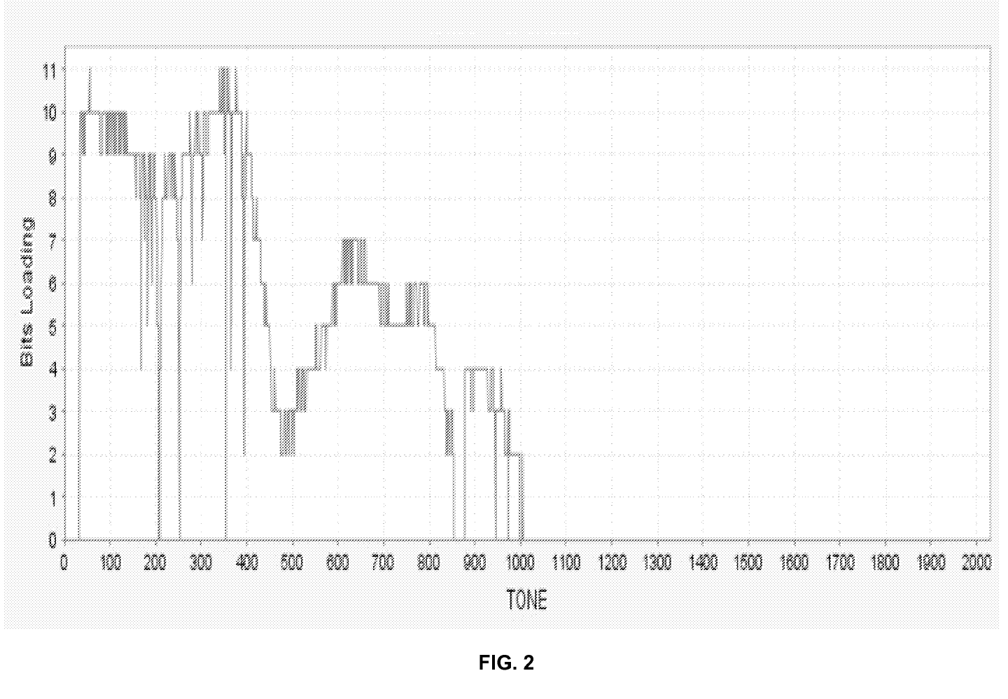

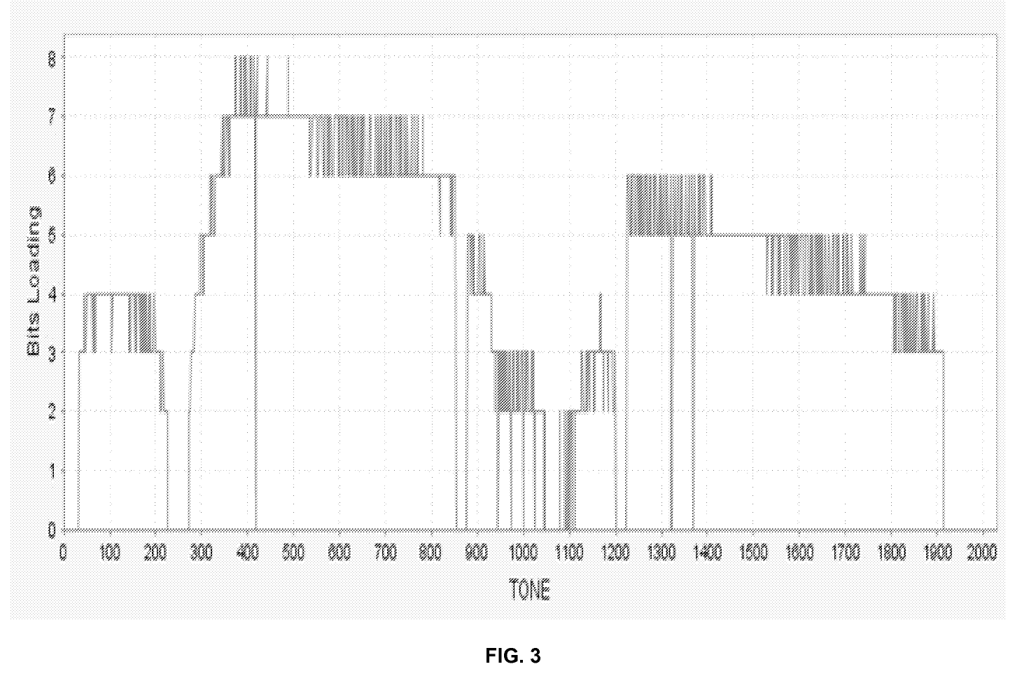

Long loop lengths may have a negative impact to services provided to a customer as illustrated by FIG. 2 and FIG. 3. FIG. 2 depicts bits loading versus tone for a first particular digital subscriber line. The loop length of the first particular digital subscriber line is about 2500 feet. FIG. 3 depicts bits loading versus tone for a second particular digital subscriber line. The loop length of the second particular digital subscriber line is about 850 feet. High frequency channel slots may not be available for longer loop lengths, such as for the first digital subscriber line of FIG. 2. The customer associated with FIG. 2 may have unsatisfactory service, such as pixelization, instances of loss of service and re-initialization, downstream bit rates that may be limited by downstream forward error correction (FEC), and upstream bit rates that may be impacted by FEC and severely errored seconds (SES). The customer associated with FIG. 2 may repeatedly request service calls to try and fix quality issues, may cancel service, may disparage the service, or combinations thereof. A customer requesting an installation of a digital subscriber line near to the customer associated with FIG. 2 may have similar problems.

Some customers may have satisfactory service. Bandwidth used by these customers may be spread throughout a part of a radio frequency (RF) spectrum used by the customers. For example, the customer associated with FIG. 3 may have satisfactory service. A customer requesting an installation of a digital subscriber line near to the customer associated with FIG. 3 may also have satisfactory performance.

Some customers may have satisfactory service, but the bandwidth providing the satisfactory service is biased in an upper portion of a radio frequency (RF) spectrum used by such customers. These customers may have relative short loop lengths that extend up to about 2000 feet. These existing customers may provide indications that subsequent customers requesting service who have longer loop lengths (e.g., in the general range of 2000 to 3000 feet) and are located near these customers may have difficulty obtaining quality service. One reason that the bandwidth may be biased in the upper part of the RF spectrum used by the customers may be noise-related impairments in a lower portion of the RF spectrum used by the customers. Low-frequency impairments may include, but are not limited to, AM broadcast interference into a local loop, high pass filter installation on a residential gateway (RG) interface to the local loop, AM broadcast interference into household wiring that impairs the RG, and cable plant quality issues in the local loop.

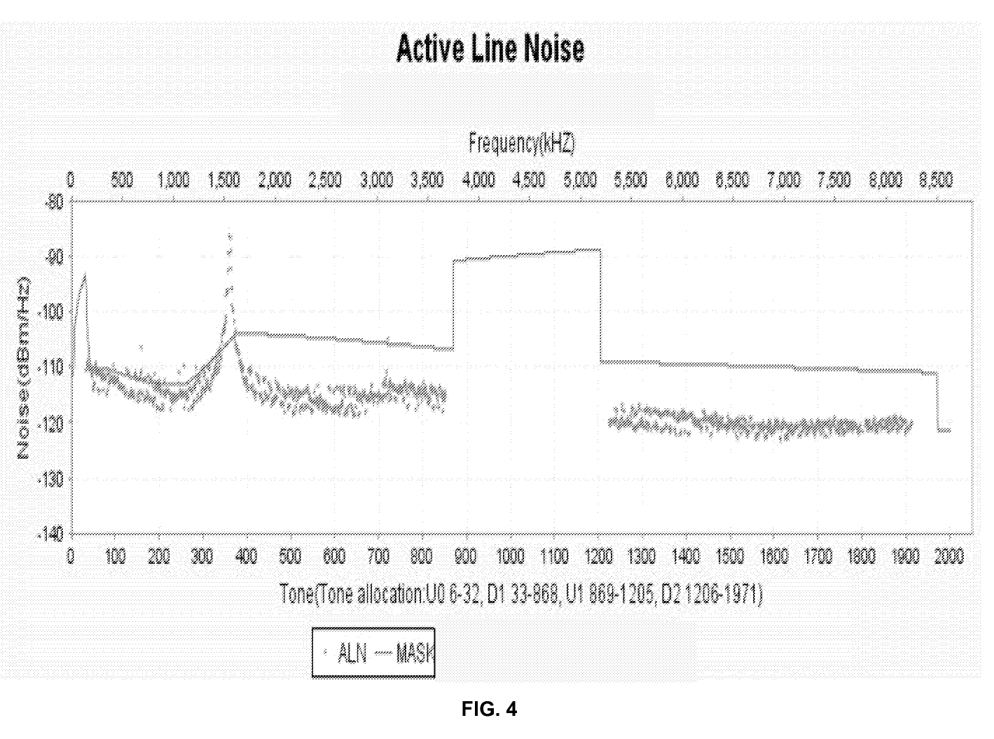

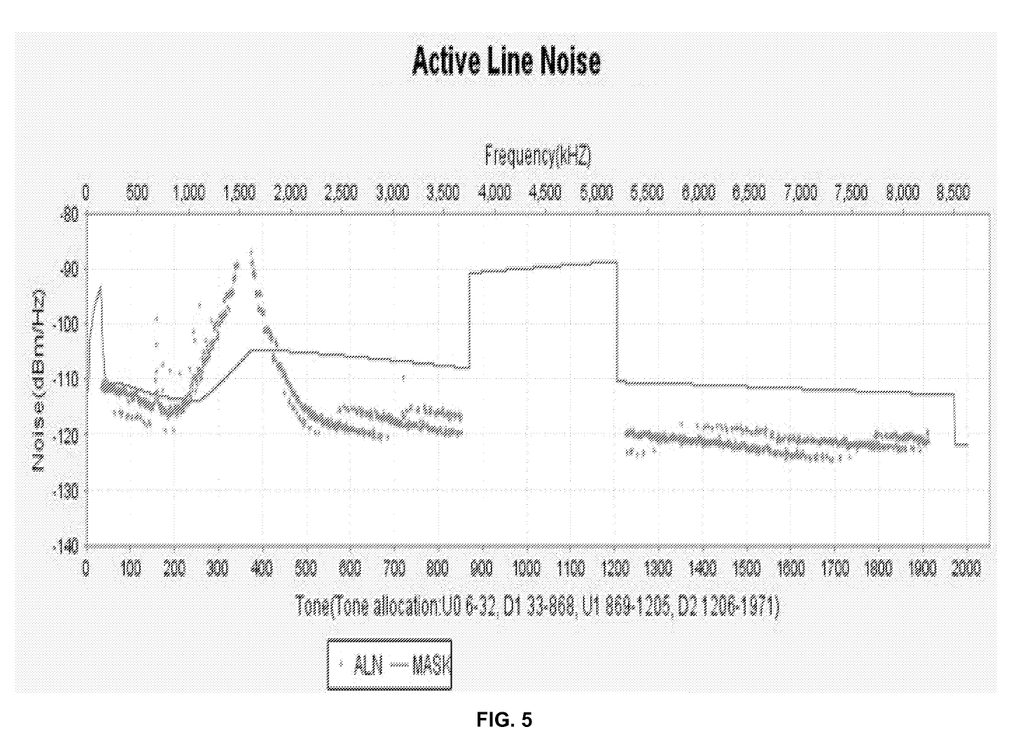

In particular embodiments, high pass filter installation on the RG interface to the local loop may be used to manage AM broadcast interference into the local loop, AM broadcast interference into wiring of a household, or both. FIG. 4 depicts a graph showing active line noise in a digital subscriber line without a high pass filter. The graph shows noise (dB m/Hz) versus frequency (kHz) and noise versus tone. The graph shows data for the active line noise and a mask. FIG. 5 depicts a graph showing active line noise for the same digital subscriber line as in FIG. 4, but with a high pass filter. The graph shows noise (dB m/Hz) versus frequency (kHz) and noise versus tone. The graph shows data for the active line noise and a mask.

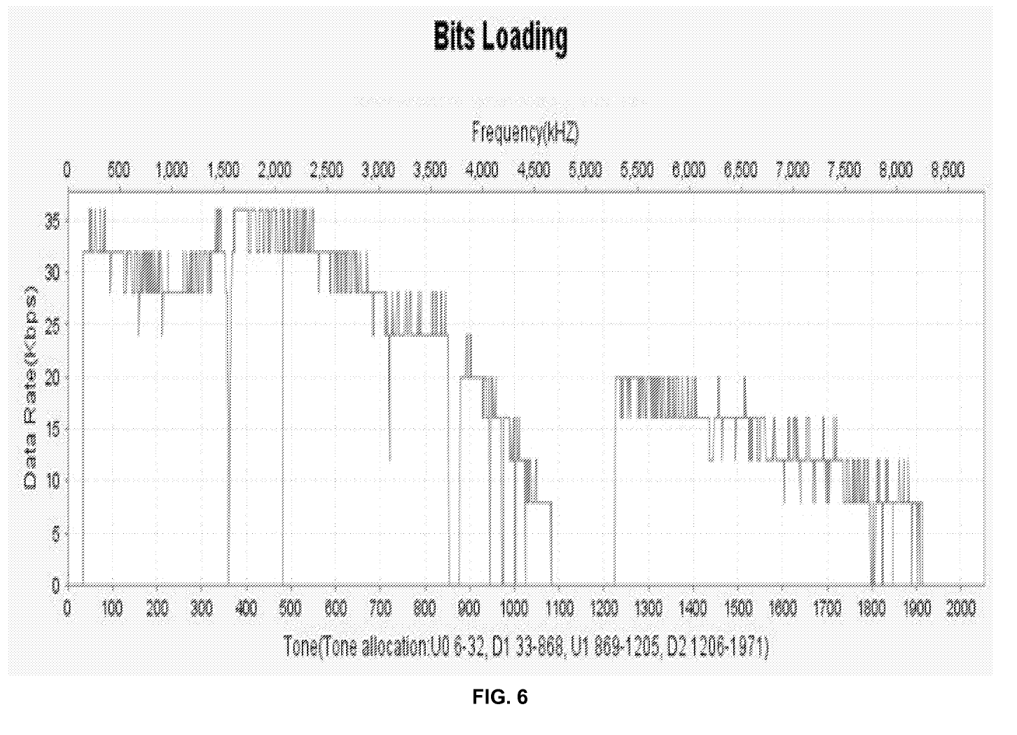

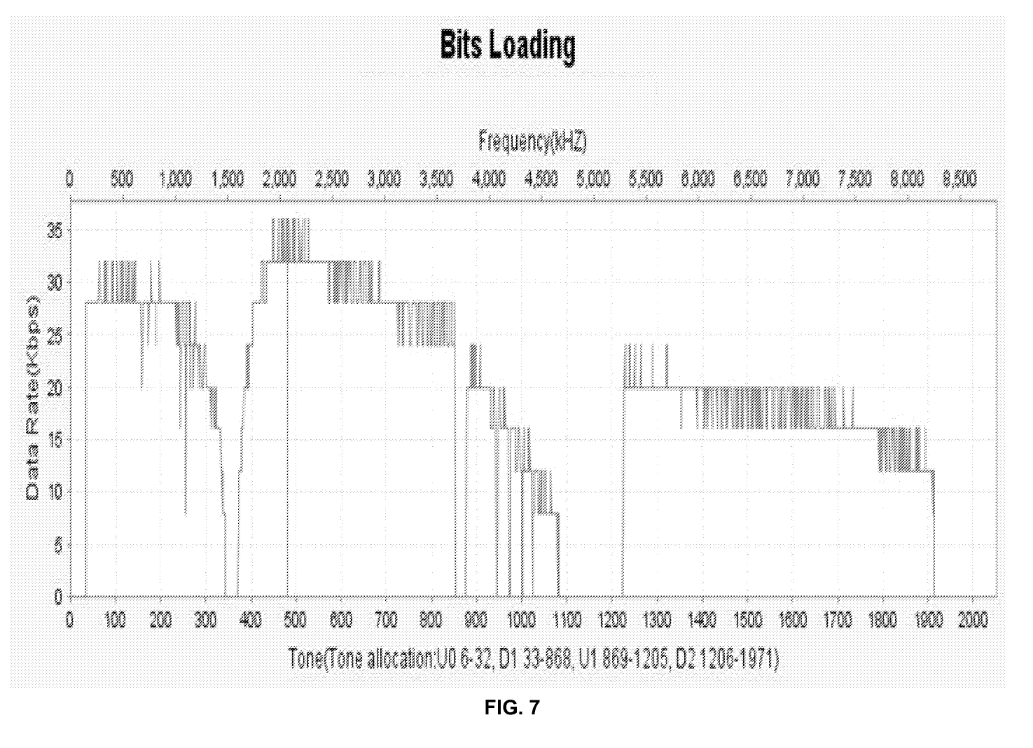

FIG. 6 depicts a graph of bits loading for the digital subscriber line corresponding to FIG. 4 without the high pass filter. The low frequency spectrum may be impaired. The impairments may cause errors. FIG. 7 depicts a graph of bits loading for the digital subscriber line corresponding to FIG. 5 with the high pass filter. The high pass filter may cause a heavier dependence on the high frequency portions of the spectrum. The use of the high pass filter may result in fewer errors and fewer re-initializations of service.

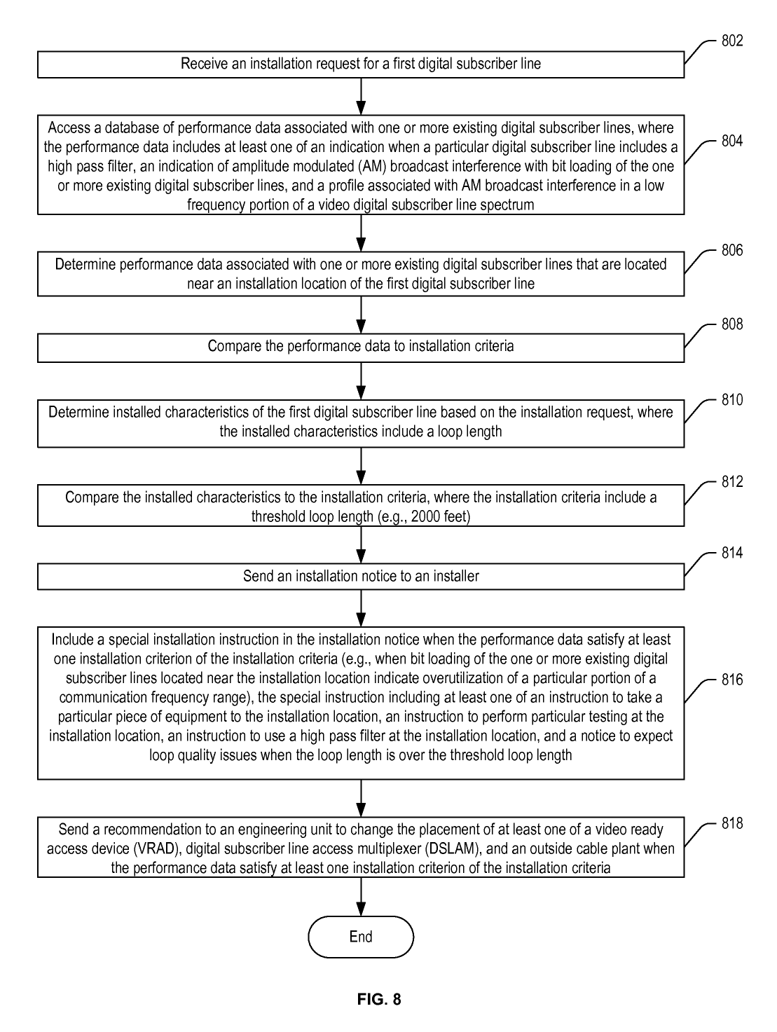

Referring to FIG. 8, a particular embodiment of a method to facilitate installation of a digital subscriber line is illustrated. The method may include, at 802, receiving an installation request for a first digital subscriber line. In a particular embodiment, the installation request may be received at a central office of a broadband services provider and may be forwarded to an installation system (e.g., the central office 132 and the installation system 102 depicted in FIG. 1).

After receiving the installation request, a database of performance data associated with one or more existing digital subscriber lines may be accessed, at 804. Performance data from the database may include, but is not limited to, an indication when a particular digital subscriber line includes a high pass filter, an indication of amplitude modulated (AM) broadcast interference with bit loading of the one or more existing digital subscriber lines, and a profile associated with AM broadcast interference in a low frequency portion of a video digital subscriber line spectrum.

The method may include, at 806, determining performance data associated with one or more existing digital subscriber lines that are located near an installation location of the first digital subscriber line. The existing digital subscriber lines may use the same equipment as will be used to support the first digital subscriber line (e.g., the same cable plant, the same VRAD, and the same DSLAM). The performance data may be compared to installation criteria, at 808.

The method may include, at 810, determining installed characteristics of the first digital subscriber line based on the installation request. The installed characteristics may include a loop length for the first digital subscriber line. The installed characteristics may be compared to the installation criteria, at 812. The installation criteria may include a threshold loop length. In a particular embodiment, the threshold loop length may be about 2000 feet. In other embodiments, the threshold loop length may be shorter or longer than 2000 feet (e.g., about 1500 feet or about 2500 feet).

The method may include, at 814, sending an installation notice to an installer. The method may include, at 816, including a special installation instruction in the installation notice when the performance data, the installed characteristics, or both satisfy at least one installation criterion of the installation criteria. For example, the satisfied installation criterion may be satisfied when bit loading of the one or more existing digital subscriber lines located near the installation location indicate overutilization of a particular portion of a communication frequency range. The special instruction may include at least one of an instruction to take a particular piece of equipment to the installation location, an instruction to perform particular testing at the installation location, an instruction to use a high pass filter at the installation location, and a notice to expect loop quality issues when the loop length is over the threshold loop length. The special instruction may include other instructions, notices, or comments as appropriate.

A recommendation may be sent to an engineering unit when the performance data or the installed characteristics satisfy at least one installation criterion of the installation criteria, at 818. The recommendation may be to change equipment associated with the new digital subscriber line. The change may entail installing new equipment to serve a particular area, updating existing equipment to increase the performance of the equipment, moving existing equipment to reduce the average loop length of customers served by the equipment, or combinations thereof.

Embodiments disclosed herein facilitate installation of new digital subscriber lines with improved performance characteristics. The systems and methods to facilitate installation of new digital subscriber lines may result in improved service for customers, may improve customer satisfaction, may result in the loss of fewer customers, may increase market share and may increase revenue. The systems and methods to facilitate installation of new digital subscriber lines may result in fewer tickets to network care and customer care, may reduce operations costs, may result in fewer service calls dispatched to customer premises, and may result in fewer dispatches to repair network equipment. The systems and methods to facilitate installation of new digital subscriber lines may also result in better planning of VRAD and DSLAM placement and may result in better preparation of a local cable plant, especially at cross-boxes.

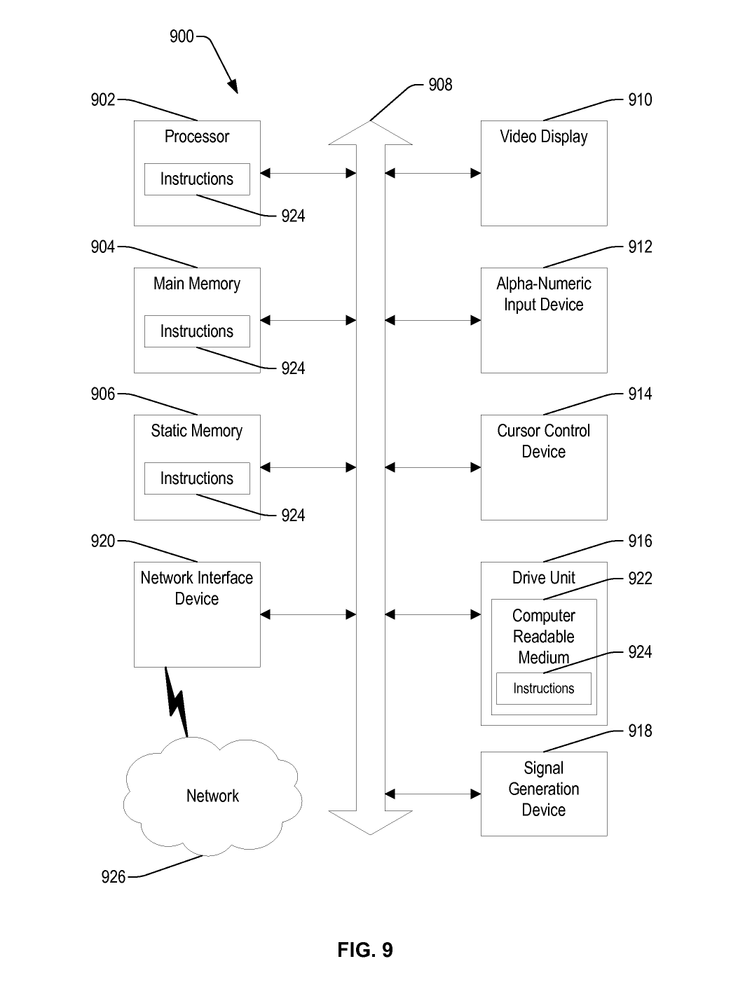

Referring to FIG. 9, an illustrative embodiment of a general computer system is shown and is designated 900. The computer system 900 may include a set of instructions that can be executed to cause the computer system 900 to perform any one or more of the methods or computer based functions disclosed herein. The computer system 900 may operate as a standalone device or may be connected, e.g., using a network, to other computer systems or peripheral devices. For example, the computer system 900 may include or be included within any one or more of the installation system 102, the central office 132, the outside cable plant 134, the VRAD 136, the DSLAM 138, the installer communication device 142, and the engineering unit communication device 144 described with reference to FIG. 1.

In a networked deployment, the computer system 900 may operate in the capacity of a server or as a client user computer in a server-client user network environment, or as a peer computer system in a peer-to-peer (or distributed) network environment. The computer system 900 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a web appliance, or any other machine capable of executing a set of instructions (sequential or otherwise) that specify actions to be taken by that machine. In a particular embodiment, the computer system 900 may be implemented using electronic devices that provide video, audio, or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics processing unit (GPU), or both. Moreover, the computer system 900 may include a main memory 904 and a static memory 906, which can communicate with each other via a bus 908. As shown, the computer system 900 may further include a video display unit 910, such as a liquid crystal display (LCD), a projection television system, a flat panel display, or a solid state display. Additionally, the computer system 900 may include an input device 912, such as a keyboard, and a cursor control device 914, such as a mouse. The computer system 900 may also include a disk drive unit 916, a signal generation device 918, such as a speaker or remote control, and a network interface device 920. Some computer systems 900 may not include an input device (e.g., a server may not include an input device).

In a particular embodiment, as depicted in FIG. 9, the disk drive unit 916 may include a computer-readable storage medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionality as described herein.

The present disclosure contemplates a computer-readable storage medium that stores instructions 924 or receives, stores and executes instructions 924 responsive to a propagated signal, so that a device connected to a network 926 may communicate voice, video or data over the network 926. Further, the instructions 924 may be transmitted or received over the network 926 via the network interface device 920.

While the computer-readable storage medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing or encoding a set of instructions for execution by a processor or that cause a computer system to perform any one or more of the methods or operations disclosed herein.

In a particular non-limiting, exemplary embodiment, the computer-readable storage medium may include a solid-state memory such as a memory card or other package that houses one or more non-volatile read-only memories. Further, the computer-readable storage medium may be a random access memory or other volatile re-writable memory. Additionally, the computer-readable storage medium may include a magneto-optical or optical medium, such as a disk or tapes or other storage device. A digital file attachment to an e-mail or other self-contained information archive or set of archives may be considered equivalent to a tangible storage medium. Accordingly, the disclosure is considered to include any one or more of a computer-readable storage medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP, IEEE 802.x) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A computer-implemented method, comprising:
receiving an installation request for a digital subscriber line;
determining performance data associated with one or more active digital subscriber lines that are located near an installation location of the digital subscriber line;
comparing the performance data to installation criteria; and
sending an installation notice to an installer, wherein the installation notice includes a special installation instruction when the performance data satisfies at least one installation criterion of the installation criteria.

2. The computer-implemented method of claim 1, further comprising:
determining installed characteristics of the digital subscriber line based on the installation request; and
comparing the installed characteristics to the installation criteria;
wherein the installation notice is sent when the installed characteristics satisfy at least one installation criterion of the installation criteria.

3. The computer-implemented method of claim 2, wherein the installed characteristics include a loop length.

4. The computer-implemented method of claim 1, wherein determining the performance data comprises accessing a database of performance data associated with the one or more active digital subscriber lines.

5. The computer-implemented method of claim 3, wherein the installation notice includes a warning to expect loop quality issues when the loop length is over about 2000 feet.

6. The computer-implemented method of claim 1, wherein the performance data satisfy the at least one installation criterion when bit loading of the one or more active digital subscriber lines indicates overutilization of a particular portion of a communication frequency range of the one or more active digital subscriber lines.

7. The computer-implemented method of claim 1, wherein the special installation instruction includes an instruction to take a particular piece of equipment to the installation location of the digital subscriber line when the digital subscriber line is installed.

8. The computer-implemented method of claim 1, wherein the special installation instruction includes an instruction to perform particular testing at the installation location of the digital subscriber line.

9. The computer-implemented method of claim 1, wherein the special installation instruction includes an instruction to use a high pass filter at the installation location.

10. The computer-implemented method of claim 1, wherein the performance data includes an indication when a particular digital subscriber line of the one or more active digital subscriber lines includes a high pass filter.

11. The computer-implemented method of claim 1, wherein the performance data include an indication of amplitude modulated (AM) broadcast interference with bit loading of the one or more active digital subscriber lines.

12. The computer-implemented method of claim 1, wherein the performance data include a profile associated with amplitude modulated (AM) broadcast interference in a low frequency portion of a digital subscriber line spectrum.

13. A system comprising:
a processor; and
a processor-readable storage medium coupled to the processor, wherein the processor-readable storage medium includes instructions executable by the processor to:
receive an installation request for a digital subscriber line;
determine performance data associated with one or more active digital subscriber lines located near an installation location of the digital subscriber line;
determine an estimated loop length of the first digital subscriber line; and
provide a special notice to an installer when at least one of the performance data indicate amplitude modulated (AM) broadcast interference in a low frequency portion of the one or more active digital subscriber lines, use of high pass filtering measures on the one or more active digital subscriber lines, and the estimated loop length satisfies a threshold.

14. The system of claim 13, wherein the notice comprises instructions to use high pass filters on in-house ports connected to customer premises equipment when the digital subscriber line is installed.

15. The system of claim 13, wherein the processor-readable storage medium further includes instructions to send a notice to an engineering unit to change a placement of a video remote access device (VRAD).

16. The system of claim 13, wherein the processor-readable storage medium further includes instructions to send a notice to an engineering unit to adjust a digital subscriber line access multiplexer (DSLAM).

17. The system of claim 13, wherein the processor-readable storage medium further includes instructions to send a notice to an engineering unit to change a placement of an outside cable plant.

18. The system of claim 13, wherein the threshold is about 2000 feet.

19. A computer-readable storage medium, comprising:
operational instructions that, when executed by a processor, cause the processor to receive an installation request for a new digital subscriber line;
operational instructions that, when executed by the processor, cause the processor to determine whether active digital subscriber lines located near an installation location of the new digital subscriber line have low frequency impairments; and
operational instructions that, when executed by the processor, cause the processor to provide a notice to an installer of the new digital subscriber line to use high pass filters on in-house ports connected to customer premises equipment when the active digital subscriber lines have low frequency impairments.

20. The computer-readable storage medium of claim 19, further comprising operational instructions that, when executed by the processor, cause the processor to send a recommendation to an engineering unit to change a loop length for the new digital subscriber line when the loop length is over a threshold.
